(19) United States
(12) Patent Application Publication
(10) Pub. No.: US 2010/0193422 A1
(43) Pub. Date: Aug. 5, 2010

(54) AIR OR WATER FILTRATION AND REMEDIATION SYSTEM

(76) Inventors: FREDRICK JAMES SAWAYA, FARMINGTON HILLS, MI (US); VINCENT FELICE SALVIA, ROCHESTER HILLS, MI (US)

Correspondence Address: SMIRMAN IP LAW, PLLC, P.O. BOX 80364, ROCHESTER, MI, 48308, US

(21) Appl. No.: 12/478,094

(22) Filed: Jun. 4, 2009

Related U.S. Application Data
(60) Provisional application No. 61/130,925, filed on Jun. 4, 2008.

(51) Int. Cl. C02F 9/04; C02F 1/62; C02F 1/32; C02F 1/72; C02F 1/42; B01J 15/00; C02F 101/20

(52) U.S. Cl. 210/202; 210/206; 422/188

(57) ABSTRACT

A multi-stage air and water filtration and remediation system is described that can destroy, neutralize, or otherwise facilitate the elimination of many types of microorganisms (e.g., bacteria, viruses, fungi, protozoans, and so forth), hazardous chemicals (e.g., heavy metals, radioactive species, poisonous gases, hormones, and so forth), and other harmful substances contained in contaminated air and water. The filtration and remediation system includes exposure of the contaminated air or water to an iodine-containing stage, a sulfur-containing stage, an oxidation stage, an anion resin stage, a centrifugation stage (for the contaminated water only), and a carbon-containing stage. The introduction of the contaminated air or water into, and through, the filtration and remediation system can be accomplished by gravity flow or pressure, various pumps, suction devices, and so forth. Additionally, optional iodine removal, UV radiation, ozonation, and re-titration stages can also be provided. The various stages can be positioned relative to one another in a specific configuration or sequence for maximum benefit and efficacy.

### CROSS-REFERENCE TO RELATED APPLICATION

The instant application claims priority to U.S. Provisional Patent Application Ser. No. 61/130,925, filed Jun. 4, 2008, the entire specification of which is expressly incorporated herein by reference.

### FIELD OF THE INVENTION

The present invention relates generally to air and water filters and remediation techniques, and, more specifically, to an air or water filtration and remediation system that can destroy, neutralize, or otherwise facilitate the elimination of many types of microorganisms (e.g., bacteria, viruses, fungi, protozoans, and so forth), hazardous chemicals (e.g., heavy metals, radioactive species, poisonous gases, hormones, and so forth), and other harmful substances contained in contaminated air and water so as to offer a safer alternative to the management of infected or contaminated air and water.

### BACKGROUND OF THE INVENTION

The large scale introduction and widespread use of numerous household and industrial chemicals over the past century has led to pervasive pollution of both air and water sources. This pollution has also led to various health problems in those individuals exposed to those chemicals, whether it be direct exposure during use and handling of those chemicals, or indirect exposure by breathing air containing the chemicals (or byproducts thereof) or drinking water contaminated by the chemicals (or byproducts thereof). These chemicals can take many forms, including pesticides, herbicides, fuels, solvents, hormones, fertilizers, medications, and the like. Additionally, these chemicals may contain substances such as heavy metals, toxic metals, and other harmful compounds, including arsenic, cadmium, chromium, copper, cyanide, lead, mercury, nickel, and so forth, which are generally known to cause serious health problems, even after limited exposure thereto.

Another problem with current air and water conditions is the widespread contamination by microorganisms, such as bacteria, viruses, fungi, protozoans, and so forth. While many of these microorganisms may be harmless to healthy individuals, several of them (e.g., Anthrax bacteria, Syphilis bacteria, Ebola virus, Polio virus, Smallpox virus, Measles virus, Mumps virus, toxic black molds, Malaria protozoan parasites, and so forth) can cause very serious diseases, especially to those individuals with compromised or challenged immune systems, such as hospital patients. These microorganisms are very easily carried in the air and can easily infiltrate water supplies as well. The problem of air and water contamination by microorganisms is especially acute in developing countries, or those areas where conventional large-scale air or water treatment facilities are not readily available, impractical, or cost prohibitive.

Still another problem with the present air and water conditions is the widespread contamination by radioactive substances, such as uranium, which was widely mined during the 20^{th} century for use as a nuclear fuel or precursor material for nuclear weapons. The widespread mining, testing, and improper disposal of these radioactive materials has caused many instances of pollution of the air and water, especially in areas adjacent to mines, nuclear test sites, and nuclear material disposal sites. The exposure to even low levels of radioactive substances, especially over a long period of time, is believed to have the potential to cause human disease, including several types of cancers.

Yet another problem is the contamination, whether intentional or unintentional, of the air and water with various chemical warfare agents, such as Saran gas, mustard gas, and so forth, which can quickly cause disability or death, even in minute amounts. While various military organizations exercise extreme care with the handling and disposal of these lethal substances, various terrorist organizations could potentially acquire or produce these compounds for use in attacks on civilian targets, including large metropolitan areas, in order to cause widespread casualties.

While various techniques for removing these above-described contaminants from the air and water have been proposed, many rely on physical filtration methods that may, to some degree, remove one type of contaminant, but is simultaneously woefully inadequate for removing another type of contaminant. Likewise, the use of biological or chemical remediation methods may address one type of contamination, but may be unable to neutralize or remove other types of contamination. Additionally, many of these systems are typically complex in configuration and costly to manufacture and install. Furthermore, all of these techniques typically require foreknowledge of exactly what type of contaminant is needed to be removed or neutralized in order to choose the right type of filtration or remediation system. However, in an emergency situation, this type of information is typically not readily available, and therefore it is more likely than not that a conventional filtration or remediation system would not be able to address every potential contaminant contained in the air or water to be treated.

Therefore, it would be advantageous to provide a new and improved air and water filtration and remediation system that overcomes at least one of the aforementioned problems.

### SUMMARY OF THE INVENTION

In accordance with the general teachings of the present invention, a new and improved air or water filtration and remediation system is provided that can destroy, neutralize, or otherwise facilitate the elimination of many types of microorganisms (e.g., bacteria, viruses, fungi, protozoans, and so forth), hazardous chemicals (e.g., heavy metals, radioactive species, poisonous gases, hormones, and so forth), and other harmful substances contained in contaminated air and water. In accordance with one aspect of the present invention, the filtration and remediation system includes exposure of the contaminated air or water to an iodine-containing stage, a sulfur-containing stage, an oxidation stage, an anion resin stage (e.g., for removal or deionization of iodide); a centrifugation stage (for treatment of the contaminated water only), and a carbon-containing stage. In accordance with another aspect of the present invention, the introduction of the contaminated air or water into, and through, the filtration and remediation system can be accomplished by gravity flow or pressure, various pumps, suction devices, and so forth. Additionally, optional iodine removal, UV radiation, ozonation (i.e., treatment with O₃) and re-titration stages can also be provided in conjunction with the primary treatment stages of the present invention. In accordance with yet another aspect of the present invention, the various stages can be positioned relative to one another in a specific configuration or sequence for maximum benefit and efficacy.

In accordance with one embodiment of the present invention, an air or water filtration and remediation system is provided for treating a contaminated fluid, comprising: (1) an iodine-containing stage; (2) a sulfur-containing stage in fluid communication with the iodine-containing stage; (3) an oxidation stage in fluid communication with the sulfur-containing stage; (4) an anion resin stage in fluid communication with the oxidation stage; and (5) a carbon-containing stage in fluid communication with the anion resin stage.

In accordance with an alternative embodiment of the present invention, a water filtration and remediation system is provided for treating a contaminated fluid, comprising: (1) a fluid conduit or container; and (2) an iodine-containing stage disposed in or on the fluid conduit or container, wherein the iodine-containing stage includes a concentric series of layers having interstices formed therein for allowing the contaminated fluid to flow through the concentric layers and contact the iodine-containing stage in order to treat the contaminated fluid.

In accordance with another alternative embodiment of the present invention, a water filtration and remediation system is provided for treating a contaminated fluid, comprising: (1) a fluid conduit or container; (2) an iodine-containing stage disposed in or on the fluid conduit or container; and (3) a carbon-containing stage disposed in the fluid conduit or container, wherein the contaminated fluid is permitted to flow through the fluid conduit or container and contact the iodine-containing stage in order to treat the contaminated fluid, wherein the carbon-containing stage is permitted to be moved back and forth through the fluid conduit or container and contact the contaminated fluid in order to treat the contaminated fluid.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is schematic view of a filtration and remediation system, in accordance with a first embodiment of the present invention;

FIG. 2 is schematic view of a first alternative filtration and remediation system, in accordance with a second embodiment of the present invention;

FIG. 3 is schematic view of a second alternative filtration and remediation system, in accordance with a third embodiment of the present invention;

FIG. 4 is schematic view of a third alternative filtration and remediation system, in accordance with a fourth embodiment of the present invention; and

FIG. 5 is schematic view of a fourth alternative filtration and remediation system, in accordance with a fifth embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

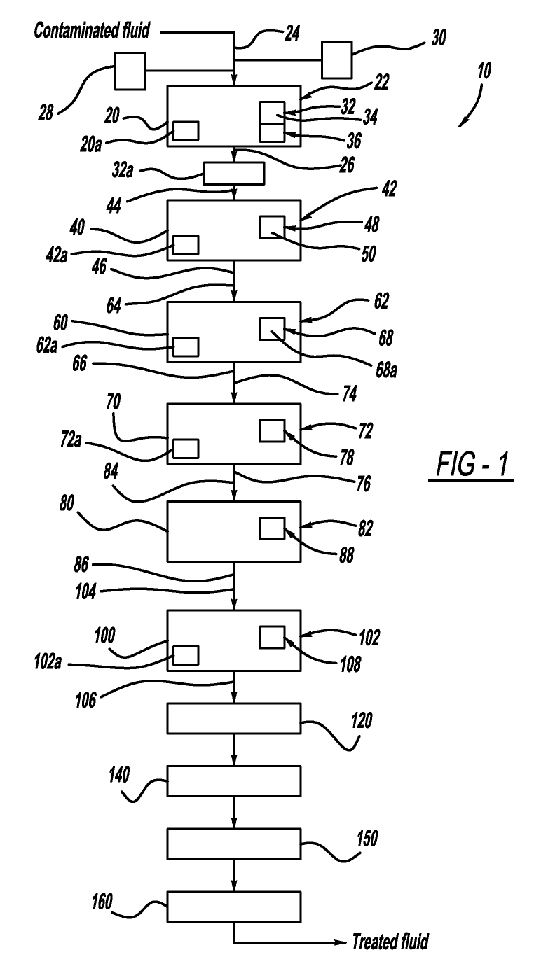

Referring to FIG. 1, there is shown a water and air filtration and remediation system generally shown at 10. It should be appreciated that the system 10 can be used for human, animal and/or agricultural applications. It should also be appreciated that the system 10 can be used for normal air and water filtration applications, as well as emergency applications, such as but not limited to power outages, mass contamination events, bioterrorism attacks, and/or the like.

In accordance with one aspect of the present invention, the system 10 permits the selective exposure of any contaminated air or water to an iodine-containing stage 20, a sulfur-containing stage 40, an oxidation stage 60, an anion resin stage 70 (e.g., for iodide removal or deionization); an optional centrifugation stage 80 (e.g., for treatment of the contaminated water only), and a carbon-containing stage 100. In accordance with another aspect of the present invention, the introduction of the contaminated air or water into, and through, the system 10 can be accomplished by gravity flow or pressure, various pumps, suction devices, and so forth, as will be further described herein.

Additionally, an optional iodine removal stage 120, an optional UV radiation stage 140, and an optional re-titration stage 160 can also be provided in conjunction with the primary treatment stages of the system 10. In accordance with yet another aspect of the present invention, the various stages can be positioned relative to one another in a specific configuration or sequence for maximum benefit and efficacy, as will be further described herein.

Referring to the iodine-containing stage 20, it can include a chamber 22 of any particular shape or design subject to an inlet 24 and an outlet 26 being provided thereon. That, is the chamber 22 needs to be able to receive an amount of contaminated air or water, e.g., through the inlet 24, and expel an amount of treated air or water, e.g., through the outlet 26. The inlet 24 can be operably associated with a conduit system (not shown) in order to receive the contaminated air or water. For example, the conduit system can be a building's water supply (or waste) pipe system (e.g., for treating contaminated water) or a building's air duct (supply and return) system (e.g., for treating contaminated air).

If the contaminated air or water is not gravity fed or poured into the system 10, it will generally be necessary to provide a method for introducing the contaminated air or water into the system 10. With respect to the treatment of pre-existing water supply and waste systems, they typically include a pump (either contained in the building or as part of a remote municipal system pumping station). In this manner, introduction of the contaminated water is not a major concern. With respect to the treatment of pre-existing air duct systems, they typically include an air blower device (either contained in the building (e.g., as part of a central heating/air conditioning system) or as part of an overall HVAC system). In this manner, introduction of the contaminated air is not a major concern.

However, if there is no pumping aid associated with the water supply and waste system, and it is impossible or impractical to rely on a gravity feed, natural water pressure, or pouring method to introduce the contaminated water into the system 10, an optional pump system 28 can be operably associated with the system 10, e.g., at the inlet 24 of the chamber 22, mounted near, on, or even inside, the chamber 22, or mounted on the outlet 26. By way of a non-limiting example, the pump system 28 can be powered by any number of methods, including but not limited to battery power. In the case of treating contaminated air in a structure not having an air blower device (or similar device for in-taking and expelling air), there would need to an optional suction system 30 can be operably associated with the system 10, e.g., at the inlet 24 of the chamber 22, mounted near, on, or even inside, the chamber 22, or mounted on the outlet 26. By way of a non-limiting example, the suction system 30 can be powered by any number of methods, including but not limited to battery power. The pumping or suction aids described here can also be used in conjunction with any of the other stages of the present invention, and are not restricted to use with chamber 22.

In accordance with one aspect of the present invention, disposed within the chamber 22 is an iodine-containing material 32, which can serve as an iodine source. The iodine-containing material 32 may be disposed on or in a substrate 34, such as, but not limited to, a sponge, cloth, disc, cylinder, matrix, gel, and/or the like. Alternatively, the iodine-containing material 32 can be selectively injected into the chamber 22 (e.g., through in inlet port formed on the chamber 22) on an as-needed basis.

One or more optional filter members 32a can be operably associated with the iodine-containing material 32, the outlet 26, and/or combinations thereof. The filter member 32a can be used to filter particulate matter, as well as matter that has been treated by the iodine-containing material 32. The filter member 32a can be an in-line type filter, a rotating disk type filter, and combinations thereof. The pore size and other physical characteristics of the filter member 32a can be adjusted depending on the particular application needs. It should also be appreciated that various filters can be used with the other treatment stages of the present invention, as appropriate.

Although many types of iodine-containing material may be used with the present invention, povidone-iodine is generally preferred. Povidone-iodine is a stable chemical complex of polyvinylpyrrolidone (i.e., povidone or PVP) and elemental iodine. It contains from about 9.0% to about 12.0% available iodine, calculated on a dry basis. Povidone-iodine is completely soluble in cold water, ethyl alcohol, isopropyl alcohol, polyethylene glycol, and glycerol. Its stability in solution is much greater than that of tincture of iodine or Lugol' s solution. Povidone-iodine allows the iodine to be carried in a complexed form wherein the concentration of free iodine is very low. The product thus serves as an iodophor. In addition, it has been demonstrated that bacteria do not develop resistance to povidone-iodine, and the sensitization rate to the product is only about 0.7%. Consequently, povidone-iodine has found broad application in medicine as a surgical scrub; for pre- and post-operative skin cleansing; for the treatment and prevention of infections in wounds, ulcers, cuts and burns; for the treatment of infections in decubitus ulcers and stasis ulcers; in gynecology for vaginitis associated with candidal, trichomonal or mixed infections. For these purposes povidone-iodine has been formulated at concentrations of 7.5-10.0% in solution, spray, surgical scrub, ointment, and swab dosage forms. Povidone-iodine is readily commercially available from Purdue Pharma, L.P. (Stamford, Conn.) under the trade name BETADINE.

As noted, povidone-iodine has nearly 100% killing percentage of any type of microorganism, including bacteria, viruses, fungi, protozoans, and/or the like. Thus, any microorganisms present in the contaminated air or water would be most certainly killed or rendered harmless after being exposed to the povidone-iodine in the chamber 22. Additionally, the povidone-iodine may aid in the direct or indirect removal or management of certain heavy metal compounds, such as but not limited to lead albuminate.

In order to increase the exposure of the iodine-containing material 32 to the incoming contaminated air or water, an optional rotation system 36 can be employed to selectively rotate the substrate 34. The rotation system 36 can be disposed inside the chamber 22, or alternatively, partially disposed inside the chamber 22. By way of a non-limiting example, the rotation system 36 can be powered by any number of methods, including but not limited to battery power. Alternatively, the rotation system 36 can be configured to rotate due to the flow or pressure of the incoming contaminated air or water into the chamber 22. For example, the rotation system 36 can be provided with angled fins that are acted upon by the flow or pressure of the incoming contaminated air or water into the chamber 22.

Also, the incoming fluid can be caused to be agitated (e.g., by shaking the chamber 22 itself, or incorporating an agitation system 22a within or in cooperation with the chamber 22). Without being bound to a particular theory of the present invention, it is believed that the agitation will provide enhanced exposure of the incoming fluid to the iodine-containing material 32.

Additionally, the incoming contaminated air or water is preferably disposed within the chamber 22 for a sufficient residence time to allow the iodine-containing material 32 to act thereupon. Likewise, the flow rate of the contaminated air or water through the chamber 22 can be adjusted to permit a sufficient residence time therein to allow the iodine-containing material 32 to act thereupon.

Because iodine, especially elemental iodine, tends to impart a brownish tint to the initially treated (albeit still potentially contaminated) water, or when entrained in the initially treated (albeit still potentially contaminated) air may be objectionable to certain individuals, it is desirable to remove the iodine, especially elemental iodine, from the treated air or water as it exits the chamber 22.

Referring to the sulfur-containing stage 40, it can include a chamber 42 of any particular shape or design subject to an inlet 44 and an outlet 46 being provided thereon. That, is the chamber 42 needs to be able to receive an amount of initially treated air or water, e.g., through the inlet 44, and expel an amount of further treated air or water, e.g., through the outlet 46. The inlet 44 can be operably associated with the outlet 26 of chamber 22 in order to receive the treated air or water. It should be noted that the previously described filter member 32a can be operably associated with the inlet 44. The intended purpose of this stage is to neutralize any microorganisms contained in the contaminated fluid, as well as to precipitate out any harmful substances contained within the contaminated fluid (e.g., especially heavy metals). Accordingly, although this stage is directed primarily to use with sulfur-containing materials, it should be appreciated that any number of suitable compounds and/or materials can be used to accomplished either or both of the two aforementioned purposes of this stage.

In accordance with one aspect of the present invention, disposed within the chamber 42 is a sulfur-containing material 48, especially those that are suitable for forming primarily sulfides, as well as sulfites and sulfates, with halides and/or cyanides. By way of a non-limiting example, the intended purpose of the sulfur-containing material 48 is to not only react with any iodine, especially elemental iodine, present in the treated (albeit still potentially contaminated) air or water, but also to react with any harmful compounds, such as heavy metals, to render them safe or convert them to a less dangerous form, such as precipitates, which can be relatively easily removed, or salts, such as sulfides, which may be easier to metabolize or less dangerous if ingested or absorbed. The iodine-containing material 48 may be disposed on or in a substrate 50, such as, but not limited to, a sponge, cloth, disc, cylinder, matrix, gel, and/or the like. Alternatively, the sulfur-containing material 48 can be selectively injected into the chamber 42 (e.g., through in inlet port formed on the chamber 42) on an as-needed basis.

Also, the incoming fluid can be caused to be agitated (e.g., by shaking the chamber 42 itself, or incorporating an agitation system 42a within or in cooperation with the chamber 42). Without being bound to a particular theory of the present invention, it is believed that the agitation will provide enhanced exposure of the incoming fluid to the sulfur-containing material 48.

Although many types of sulfur-containing material may be used with the present invention, sodium thiosulfate is generally preferred. Sodium thiosulfate (Na₂S₂O₃), also spelled sodium thiosulphate, is a colorless crystalline compound that is more familiar as the pentahydrate, Na₂S₂O₃.5H₂O, an efflorescent, monoclinic crystalline substance also called sodium hyposulfite or “hypo.” The thiosulfate anion is tetrahedral in shape and is notionally derived by replacing one of the oxygen atoms by a sulfur atom in a sulfate anion. The S—S distance indicates a single bond, implying that the sulfur bears significant negative charge and the S—O interactions have more double bond character. The first protonation of thiosulfate occurs at sulfur.

Thiosulfate anion characteristically reacts with dilute acids to produce sulfur, sulfur dioxide and water:

Na₂S₂O₃+2HCl→2NaCl+S+SO₂+H₂O

This reaction has been employed to generate colloidal sulfur. When the protonation is conducted at low temperatures, H₂S₂O₃ (thiosulfuric acid) can be obtained. It is a strong acid pKₐ=0.6, 1.7.

In analytical chemistry, the most important use comes from the fact that the thiosulfate anion reacts stoichiometrically with iodine, reducing it to iodide as it is oxidized to tetrathionate:

2S₂O₃²⁻(aq)+I₂(aq)→S₄O₆²⁻(aq)+2I⁻(aq)

Due to the quantitative nature of this reaction, as well as the fact that Na₂S₂O₃.5H₂O has an excellent shelf-life, it is used as a titrant in iodometry. Sodium thiosulfate is also useful to remove iodine, especially elemental iodine, from contaminated air or water. Likewise, sodium thiosulfate has been used to de-chlorinate tap water for aquariums or treat effluent from waste water treatments prior to release into rivers. The reduction reaction is analogous to the iodine reduction reaction.

Sodium thiosulfate is also used as an antidote to cyanide poisoning. Thiosulfate acts as a sulfur donor for the conversion for cyanide to thiocyanate (which can then be safely excreted in the urine), catalyzed by the enzyme rhodanase. Thus, sodium thiosulfate is a highly suitable substance for the removal of cyanide, which is extremely and quickly lethal to humans and other mammals, in the system 10 of the present invention. Furthermore, sodium thiosulfate is able to bind several heavy metals (e.g., in the form of sulfides, sulfites and/or sulfates) in an insoluble form of the heavy metal, thus causing the heavy metals contained in contaminated water to be precipitated out of solution.

Sodium thiosulfate is also believed to be able to kill or neutralize various fungi and protozoans, and thus would be useful as an agent to kill or neutralize those various fungi and protozoans not killed by the iodine-containing stage 20.

Sodium thiosulfate is readily commercially available from Mallinckrodt Baker, Inc. (Phillipsburg, N.J.).

The incoming treated (albeit still potentially contaminated) air or water is preferably disposed within the chamber 42 for a sufficient residence time to allow the sulfur-containing material 48 to act thereupon Likewise, the flow rate of the treated (albeit still potentially contaminated) air or water through the chamber 42 can be adjusted to permit a sufficient residence time therein to allow the sulfur-containing material 46 to act thereupon.

Because the reaction of the sodium thiosulfate with the chemical species in the previously treated (albeit still potentially contaminated) water or air may produce some amounts of hydrogen sulfide (H₂S), which can be toxic to humans and mammals, and sulfur dioxide (SO₂), which can be objectionable due to its “rotten egg” odor, in the previously treated (albeit still potentially contaminated) water or air, it is desirable to remove the hydrogen sulfide and sulfur dioxide from the previously treated air or water as it exits the chamber 42. It is also believed that the hydrogen sulfide (H₂S) may be able to react with some of the metallic species in the contaminated air or water to precipitate the metals out of solution (e.g., in the case of contaminated water).

Referring to the oxidation stage 60, it can include a chamber 62 of any particular shape or design subject to an inlet 64 and an outlet 66 being provided thereon. That, is the chamber 62 needs to be able to receive an amount of previously treated air or water, e.g., through the inlet 64, and expel an amount of still further treated air or water, e.g., through the outlet 66. The inlet 64 can be operably associated with the outlet 46 of chamber 42 in order to receive the previously treated air or water.

In accordance with one aspect of the present invention, disposed within the chamber 62 is an oxidizing material 68, especially those that are suitable for containing and/or generating various bleaches, hydroxides (e.g., sodium hydroxide (NaOH), potassium hydroxide (KOH), and/or the like) and/or peroxides (H₂O₂). The oxidizing material 68 can serve as both a physical filter, as well as an oxidizing source. The oxidizing material 68 may be disposed on or in a substrate 68a, such as, but not limited to, a sponge, cloth, disc, cylinder, matrix, gel, and/or the like. Alternatively, the oxidizing material 68 can be selectively injected into the chamber 62 (e.g., through in inlet port formed on the chamber 62) on an as-needed basis.

Also, the incoming fluid can be caused to be agitated (e.g., by shaking the chamber 62 itself, or incorporating an agitation system 62a within or in cooperation with the chamber 62). Without being bound to a particular theory of the present invention, it is believed that the agitation will provide enhanced exposure of the incoming fluid to the oxidizing material 68.

Although many types of oxidizing material may be used with the present invention, chemical bleaches including, but not limited to a solution of approximately 3-6% sodium hypochlorite (NaClO), oxygen bleaches including, but not limited to hydrogen peroxide or a peroxide-releasing compound such as sodium perborate, sodium percarbonate, sodium persulfate, sodium perphosphate, or urea peroxide together with catalysts and activators, e.g., tetraacetylethylenediamine and/or sodium nonanoyloxybenzenesulfonate, bleaching powder, such as but not limited to calcium hypochlorite, various hydroxides, and/or various peroxides, are generally preferred.

Bleach is readily commercially available from The Clorox Company (Oakland, Calif.) under the trade name CLOROX.

The process of bleaching can be summarized in the following set of chemical reactions:

Cl₂(aq)+H₂O(l)- [symbol] H⁺(aq)+Cl⁻(aq)+HClO(aq)

The H⁺ ion of the hypochlorous acid then dissolves into solution, and so the final result is effectively:

Cl₂(aq)+H₂O(l) [symbol] 2H⁺(aq)+Cl⁻(aq)+ClO⁻(aq)

The broad-spectrum effectiveness of bleach, for example sodium hypochlorite, owes to the nature of the chemical reactivity of the bleach with the microbes. Rather than act in an inhibitory or specific toxic fashion in the manner of antibiotics, the reaction with the microbial cells quickly and irreversibly denatures, and often destroys the pathogen. Specifically, with sodium hypochlorite it is found that the bleach attacks proteins in bacteria, causing them to clump up much like an egg that has been boiled, when exposed to bleach, the heat shock protein of bacteria become active in an attempt to protect other proteins in the bacteria from losing their chemical structure, forming clumps that would eventually die off, and the human immune system produces hypochlorous acid in response to infection to kill bacterial invaders. As noted, the range of microorganisms effectively killed by bleach, and in particular sodium hypochlorite, is extensive, making it extremely versatile.

Treatment of solutions with sulfur dioxide results in sulfite salts and water, as shown in the following illustrative reaction with sodium hydroxide:

SO₂+2NaOH→Na₂SO₃+H₂O

Treatment of solutions with hydrogen sulfide results in elemental sulfur and water, as shown in the following illustrative reaction with hydrogen peroxide:

H₂S+8H₂O₂→S₈+16H₂O

As noted, the oxidizing material, including various bleaches, hydroxides and/or peroxides are also believed to be able to kill or neutralize various micro-organisms, and thus would be useful as an agent to kill or neutralize those various micro-organisms not killed by the iodine-containing stage 20 and/or the sulfur-containing stage 40. Furthermore, it is believed that various bleaches, hydroxides and/or peroxides can deactivate some tetrathiones, thiosulfates and/or the like, should the same be introduced into the chamber 62 from the chamber 42 of the sulfur-containing stage 40.

The incoming previously treated (albeit still potentially contaminated) air or water is preferably disposed within the chamber 62 for a sufficient residence time to allow the oxidizing material 68 to act thereupon. Likewise, the flow rate of the previously treated (albeit still potentially contaminated) air or water through the chamber 62 can be adjusted to permit a sufficient residence time therein to allow the oxidizing material 68 to act thereupon.

Because some amounts of iodide (e.g., iodine anions, I⁻¹) may still be present in the recently treated (albeit still potentially contaminated) water, or entrained in the recently treated (albeit still potentially contaminated) air, it is desirable to remove these materials from the treated air or water as it exits the chamber 62.

Referring to the anion resin stage 70, it can include a chamber 72 of any particular shape or design subject to an inlet 74 and an outlet 76 being provided thereon. That, is the chamber 72 needs to be able to receive an amount of recently treated air or water, e.g., through the inlet 74, and expel an amount of further treated air or water, e.g., through the outlet 76. The inlet 74 can be operably associated with the outlet 66 of chamber 62 in order to receive the treated air or water. The anion resin stage 70 can include, for example, an anion exchange resin material 78 disposed within the chamber 72 that is operable to remove or deionize the iodide anions. Although this stage is primarily intended to be used with contaminated water, there may be circumstances where the anion resin stage 70 can be used with contaminated air (e.g., in conjunction with air conditioning/ventilation systems of factories where large amounts of particulate matter are typically entrained in the air and need to be removed).

Also, the incoming fluid can be caused to be agitated (e.g., by shaking the chamber 72 itself, or incorporating an agitation system 72a within or in cooperation with the chamber 72). Without being bound to a particular theory of the present invention, it is believed that the agitation will provide enhanced exposure of the incoming fluid to the anion exchange resin material 78.

Because certain dangerous substances, such as but not limited to heavy metals and/or the like, may have been precipitated out of solution, or conversely, may still be present in minute or trace amounts in the recently treated (albeit still potentially contaminated) water, or entrained in the recently treated (albeit still potentially contaminated) air, it is desirable to remove these materials from the treated air or water as it exits the chamber 72.

Referring to the centrifuge stage 80, it can include a chamber 82 of any particular shape or design subject to an inlet 84 and an outlet 86 being provided thereon. That, is the chamber 82 needs to be able to receive an amount of recently treated air or water, e.g., through the inlet 84, and expel an amount of further treated air or water, e.g., through the outlet 86. The inlet 84 can be operably associated with the outlet 76 of chamber 72 in order to receive the treated air or water. A centrifuge 88 is disposed within the chamber 82, or alternatively, the chamber 82 can be incorporated into the centrifuge 88 to form a combined centrifuge/chamber unit. Although this stage is primarily intended to be used with contaminated water, there may be circumstances where the centrifuge stage 80 can be used with contaminated air (e.g., in conjunction with air conditioning/ventilation systems of factories where large amounts of particulate matter are typically entrained in the air and need to be removed).

By way of a non-limiting example, the centrifuge 88 is caused to be selectively rotated (e.g., either through electrical or battery power) so that any particulate matter in the incoming contaminated water (or air) is forced outwardly towards the outer walls of the centrifuge 88. The particulate matter will continue to accumulate against the outer walls of the centrifuge 88 as it continues to rotate. The accumulated particulate matter can be periodically removed (e.g., the centrifuge may have to be slowed or stopped) or can be constantly and/or automatically removed over an edge portion or through a port (e.g., that can selectively open and/or close) for safe disposal. Additionally, filters can be used to trap and accumulate any particulate matter, with the filters being periodically cleaned and/or replaced.

The incoming recently treated (albeit still potentially contaminated) water (or air) is preferably disposed within the chamber 82 for a sufficient residence time to allow the centrifuge 88 to act thereupon. Likewise, the flow rate of the recently treated (albeit still potentially contaminated) water (or air) through the chamber 82 can be adjusted to permit a sufficient residence time therein to allow the centrifuge 88 to act thereupon. Centrifuges for both water and air applications are readily commercially available from a number of suppliers.

In case any other harmful materials, or residual iodine, are still contained in the treated air or water, the treated air or water is then filtered through the carbon-containing stage 100.

Referring to the carbon-containing stage 100, it can include a chamber 102 of any particular shape or design subject to an inlet 104 and an outlet 106 being provided thereon. That, is the chamber 102 needs to be able to receive an amount of currently treated air or water, e.g., through the inlet 104, and expel an amount of even still further treated air or water, e.g., through the outlet 106. The inlet 104 can be operably associated with the outlet 86 of chamber 82 in order to receive the currently treated air or water.

In accordance with one aspect of the present invention, disposed within the chamber 102 is a filtering material 108, especially those containing carbon materials. For example, carbon filtering is a method of filtering that uses a piece of activated carbon to remove contaminants and impurities, utilizing chemical adsorption. Each piece of carbon is designed to provide a large section of surface area, in order to allow contaminants the most possible exposure to the filter media. This carbon is generally activated with a positive charge and is designed to attract negatively charged water contaminants. Carbon filtering has been commonly used for water purification, and is also used in air purifiers.

Also, the incoming fluid can be caused to be agitated (e.g., by shaking the chamber 102 itself, or incorporating an agitation system 102a within or in cooperation with the chamber 102). Without being bound to a particular theory of the present invention, it is believed that the agitation will provide enhanced exposure of the incoming fluid to the filtering material 108.

Carbon filters are most effective at removing chlorine, sediment, heavy metals, cysts, and volatile organic compounds (VOCs) from water. They are not as effective at removing minerals, salts, and dissolved inorganic compounds (which, if present in the contaminated air or water, were most likely removed by the end of the centrifuge stage).

Typical particle sizes that can be removed by carbon filters range from 0.5 to 50 microns. The particle size will be used as part of the filter description. The efficacy of a carbon filter is also based upon the flow rate regulation. When the water (or air) is allowed to flow through the filter at a slower rate, the contaminants are exposed to the filter media for a longer amount of time. Carbon filters for both water and air applications are readily commercially available from a number of suppliers.

It should be noted that any of these primary stages can be used in any sequence and in any combination with one another, i.e., the stages do not necessarily have to be used in the illustrative sequence described herein.

At this point, the treated air or water is most likely to be free of any harmful materials, and in all likelihood, is potable by humans and animals. However, one or more optional processing stages can be employed, such as but not limited to an optional iodine removal stage 120, an optional UV radiation stage 140, an optional ozonation (i.e., treatment with ozone, O₃) stage 150 and an optional re-titration stage 160 in conjunction with the primary treatment stages of the system 10. It should be noted that any of these optional stages can be used in any sequence and in any combination with one another.

With respect to the optional iodine removal stage 120, this would be used if residual iodine, especially elemental iodine, was still present in the treated air or water exiting the primary treatment stages of the system 10. For example, as noted, some individuals may have sensitivity issues with iodine, and therefore removing any residual iodine, especially elemental iodine, would be desirable. By way of a non-limiting example, the treated air or water can be put through another sodium thiosulfate stage, as previously described. After this process, any residual iodine, especially elemental iodine, in the treated air or water should be completely eliminated.

With respect to the optional UV radiation stage 140, this would be used if any microorganisms were still present in the treated air or water exiting the primary treatment stages of the system 10. For example, some microorganisms may be especially hardy and virulent, and therefore prudence would dictate removing any of these types of microorganisms would be desirable. By way of a non-limiting example, the treated air or water can be exposed to a source of UV radiation (e.g., a high intensity UV light) for a sufficient period of time to cause even the most hardy and virulent microorganisms to be destroyed.

With respect to the optional ozonation stage 150, this would be used if any microorganisms were still present in the treated air or water exiting the primary treatment stages of the system 10. For example, some microorganisms may be especially hardy and virulent, and therefore prudence would dictate removing any of these types of microorganisms would be desirable. By way of a non-limiting example, the treated air or water can be exposed to a source of ozone (O₃) for a sufficient period of time to cause even the most hardy and virulent microorganisms to be destroyed.

At this point, the treated air or water is almost certain to be free of any harmful materials. However, there may be a situation where the reintroduction of an iodine-containing material back into the air or water may be advisable, even though certain individuals may be sensitive to iodine. With respect to the optional re-titration stage 160, this would be used where the need to kill as many microorganisms as completely and rapidly was urgently needed (e.g., a terrorist attack where a biohazard is introduced into a city's water supply or into a building's air conditioning system).

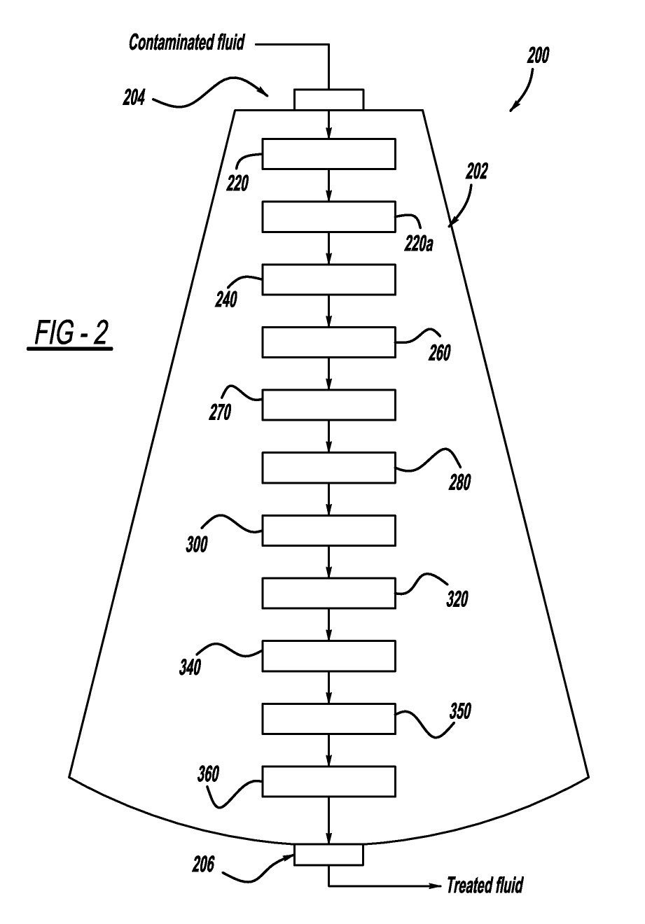

Referring to FIG. 2, there is shown a first alternative water filtration and remediation system generally shown at 200. In this embodiment, the primary stages shown in FIG. 1 have been configured in a single chamber 202 (having an inlet 204 and an outlet 206) similar to a hooded or trellised “bird bath” arrangement. The system 200 would be especially useful in those situations where the contaminated water could be fed into the system 200 by a gravity feed, thus obviating the need for any motors or pumps to transport the contaminated water there through. This system 200 accordingly would be useful in situations where electrical power was unavailable (e.g., terrorist attacks, natural disasters, rural locations, and/or the like).

In accordance with one aspect of the present invention, the system 200 permits the selective exposure of any contaminated water to an iodine-containing stage 220 (an optional filter member 220a disposed downstream of the iodine-containing stage 220), a sulfur-containing stage 240, an oxidation stage 260, an anion resin stage 270; a centrifugation stage 280, and a carbon-containing stage 300. Again, it should be appreciated that filters can be used with one or more of these treatment stages, as previously described.

Additionally, an optional iodine removal stage 320, an optional UV radiation stage 340, an optional ozonation stage 350, and an optional re-titration stage 360 can also be provided in conjunction with the primary treatment stages of the system 200. In accordance with yet another aspect of the present invention, the various stages can be positioned relative to one another in a specific configuration or sequence for maximum benefit and efficacy, as will be further described herein. It should be noted that any of these optional stages can be used in any sequence and in any combination with one another.

The functioning of the individual stages of the chamber 202 act in precisely the same manner as those described in conjunction with the embodiment depicted in FIG. 1, and therefore will not be repeated here for purposes of brevity. However, this embodiment does differ in that the contaminated water, as it is being treated, flows over the sides of the chambers of each of the stages, similar to a multi-tiered water fountain. Thus, the need for discrete inlets and outlets between the various stages can be reduced significantly.

Accordingly, the incoming contaminated water is preferably disposed within the individual stages of the chamber 202 for a sufficient residence time to allow the various materials and/or processes to act thereupon. Likewise, the flow rate of the contaminated water through the individual stages of the chamber 202 can be adjusted to permit a sufficient residence time therein to allow the individual stages of the chamber 202 to act thereupon. At the end of the primary stages (or any of the additional optional stages), the out-flowing water should be completely safe and potable.

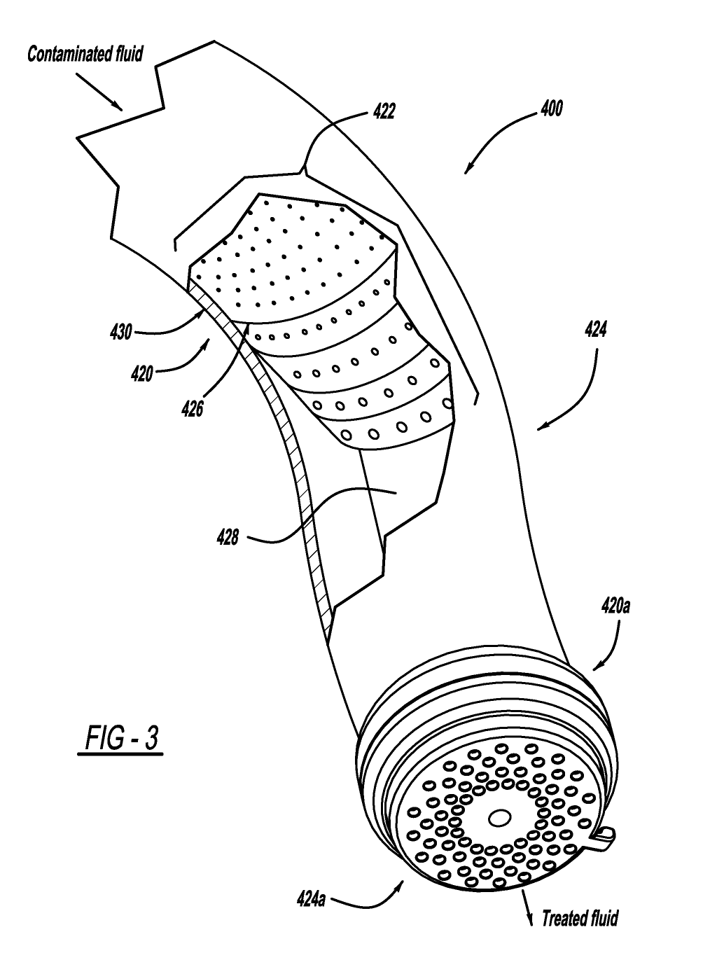

Referring to FIG. 3, there is shown a second alternative water filtration and remediation system generally shown at 400. In this embodiment, only the iodine-containing stage 420 is being used and configured as an insert 422 (e.g., an iodine-infused sponge material) in a fire hose/showerhead system 424. An optional filter member 420a can be disposed downstream of the iodine-containing stage 420 and behind the showerhead 424a). The insert 422 can be configured to have a series of “colander” like layers 426 having increasingly smaller pore sizes going from the core 428 to the outer wall 430 of the fire hose 424b. The resulting treated water enter the fire hose 424b in a large volume, and because of the decreasing pore size of the insert 422, would come out of the showerhead 424a as a fine cleaned mist. It should also be appreciated that the layers 426 can be arranged in an opposite order such that it includes increasingly larger pore sizes going from the core 428 to the outer wall 430 of the fire hose 424b. In this manner, the contaminated water can be introduced between the outer wall 430 and the insert 422 with the decontaminated water being directed towards the core 428.

The system 400 would be especially useful in those situations where the contaminated water, while being polluted with microorganisms, was nonetheless desperately needed and electrical power was available to run a pump or motor (or any other mechanism or method) to force the contaminated water through the showerhead 424a. The resulting water that was treated with iodine, while possibly containing other contaminants (e.g., heavy metals), could nonetheless be safely consumed, thus preventing dehydration and possible death. Optionally, the partially treated water could then be further treated with the other primary stages, i.e., a sulfur-containing stage, an oxidation stage, an anion resin stage, a centrifugation stage, and a carbon-containing stage (as well as the three optional stages, i.e., an optional iodine removal stage, an optional UV radiation stage, and an optional re-titration stage) of the present invention, if circumstances permitted.

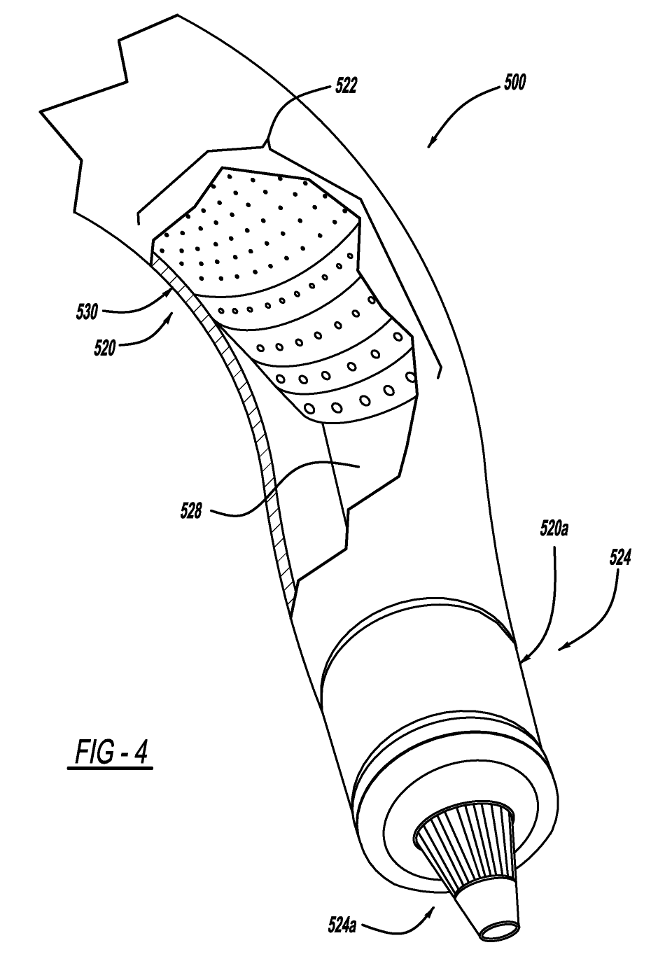

Referring to FIG. 4, there is shown a third alternative water filtration and remediation system generally shown at 500. As with the embodiment depicted in FIG. 3, only the iodine-containing stage 520 is being used and configured as an insert 522 (e.g., an iodine-infused sponge material) in a sprinkler hose system 524. An optional filter member 520a can be disposed downstream of the iodine-containing stage 520 and behind the nozzle 524a of the hose system 524). Again, the insert 522 can be configured to have a series of “colander” like layers 526 having increasingly smaller pore sizes going from the core 528 to the outer wall 530 of the hose system 524. The resulting treated water enter the hose system 524 in a large volume, and because of the decreasing pore size of the insert 522, would come out of the nozzle 524a as a fine cleaned mist. It should also be appreciated that the layers 526 can be arranged in an opposite order such that it includes increasingly larger pore sizes going from the core 528 to the outer wall 530 of the hose system 524. In this manner, the contaminated water can be introduced between the outer wall 530 and the insert 522 with the decontaminated water being directed towards the core 528.

The system 500 would be especially useful in those situations where the contaminated water, while being polluted with microorganisms, was nonetheless desperately needed and electrical power was available to run a pump or motor to force the contaminated water through the hose system 524 and out the nozzle 524a. The resulting water that was treated with iodine, while possibly containing other contaminants (e.g., heavy metals), could nonetheless be safely consumed, thus preventing dehydration and possible death. Optionally, the partially treated water could then be further treated with the other primary stages, i.e., a sulfur-containing stage, an oxidation stage, an anion resin stage, a centrifugation stage, and a carbon-containing stage (as well as the three optional stages, i.e., an optional iodine removal stage, an optional UV radiation stage, and an optional re-titration stage) of the present invention, if circumstances permitted.

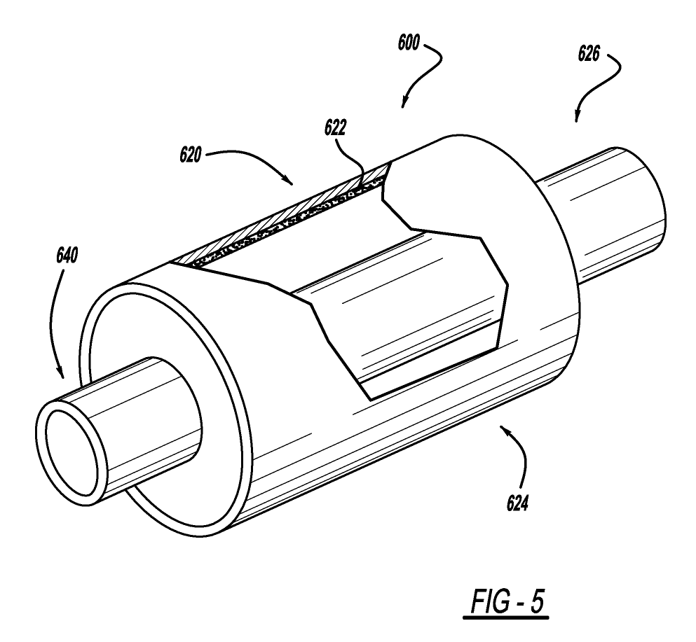

Referring to FIG. 5, there is shown a fourth alternative water filtration and remediation system generally shown at 600. This embodiment both the iodine-containing stage 620 and the carbon-containing stage 640 (the other three primary stages of the present invention not being used here) configured as an iodine coating 622 on the inner surface of the tube 624 with a carbon rod 626 being at least partially received within the tube 624. In this embodiment, contaminated water would be placed in the tube, wherein it would be contacted by the iodine coating 622, thus killing many, if not all of the microorganisms in the contaminated water. The carbon rod 626 would then be pushed/pulled through the tube 624, thus trapping any remaining microorganisms, as well as absorbing any heavy metals and/or the like, in the contaminated water. The resulting treated water could then be consumed.

The system 600 would be especially useful in those situations where the contaminated water, while being polluted with microorganisms, was nonetheless desperately needed and electrical power was not available to run a pump or motor to force the contaminated water through the tube (e.g., emergency situations, stranded travelers, combat zones, Third World countries, and/or the like). The resulting water that was treated with iodine and carbon, while possibly containing some other contaminants, could nonetheless be safely consumed, thus preventing dehydration and possible death. Optionally, the partially treated water could then be further treated with the other three primary stages, i.e., a sulfur-containing stage, an oxidation stage, and a centrifugation stage (as well as the three optional stages, i.e., an optional iodine removal stage, an optional UV radiation stage, and an optional re-titration stage) of the present invention, if circumstances permitted.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An air or water filtration and remediation system for treating a contaminated fluid, comprising:
an iodine-containing stage;
a sulfur-containing stage in fluid communication with the iodine-containing stage;
an oxidation stage in fluid communication with the sulfur-containing stage;
an anion resin stage in fluid communication with the oxidation stage; and
a carbon-containing stage in fluid communication with the anion resin stage.

2. The invention according to claim 1, further comprising a centrifugation stage in fluid communication with either the oxidation stage or the carbon-containing stage.

3. The invention according to claim 2, wherein the centrifugation stage is operable to remove any precipitated materials or particulate materials contained in the contaminated fluid.

4. The invention according to claim 1, further comprising a filtration system disposed between any two adjacent stages.

5. The invention according to claim 4, wherein the filtration system includes a filter selected from the group consisting of a fixed filter, a rotating filter, and combinations thereof.

6. The invention according to claim 1, wherein the iodine-containing stage includes a chamber having an inlet and an outlet, and an iodine-containing material disposed within the chamber.

7. The invention according to claim 6, wherein the iodine-containing stage includes a rotation member disposed within the chamber, wherein the rotation member is selectively operable to rotate the iodine-containing material.

8. The invention according to claim 6, wherein the iodine-containing material includes povidone iodine.

9. The invention according to claim 1, wherein the sulfur-containing stage includes a chamber having an inlet and an outlet, and a sulfur-containing material disposed within the chamber.

10. The invention according to claim 9, wherein the sulfur-containing material includes a material operable to react with iodine.

11. The invention according to claim 9, wherein the sulfur-containing material includes a compound operable to cause a heavy metal contained in the contaminated fluid to be precipitated out of solution.

12. The invention according to claim 9, wherein the sulfur-containing material includes a compound operable to react with a heavy metal contained in the contaminated fluid to form a sulfide compound.

13. The invention according to claim 9, wherein the sulfur-containing material includes a sulfate compound.

14. The invention according to claim 9, wherein the sulfur-containing material includes a thiosulfate compound.

15. The invention according to claim 9, wherein the sulfur-containing material includes sodium thiosulfate.

16. The invention according to claim 1, wherein the oxidation stage includes a chamber having an inlet and an outlet, and an oxidizing material disposed within the chamber.

17. The invention according to claim 16, wherein the oxidizing material includes a material operable to react with sulfur.

18. The invention according to claim 16, wherein the oxidizing material includes a material selected from the group consisting of bleach, hydroxides, peroxides, and combinations thereof.

19. The invention according to claim 1, wherein the anion resin stage includes a chamber having an inlet and an outlet, and an anion exchange resin material disposed within the chamber.

20. The invention according to claim 19, wherein the anion exchange resin material includes a material operable to remove or deionize the iodide anions.

21. The invention according to claim 1, wherein the carbon-containing stage includes a chamber having an inlet and an outlet, and a carbon-containing material disposed within the chamber.

22. The invention according to claim 21, wherein the carbon-containing material is operable to function as a filter.

23. The invention according to claim 1, further comprising a UV radiation stage in fluid communication with any of the iodine-containing stage, sulfur-containing stage, oxidation stage, anion resin stage, or carbon-containing stage.

24. The invention according to claim 1, further comprising an ozonation stage in fluid communication with any of the iodine-containing stage, sulfur-containing stage, oxidation stage, anion resin stage, or carbon-containing stage.

25. The invention according to claim 1, further comprising an agitation system in cooperation with any of the iodine-containing stage, sulfur-containing stage, oxidation stage, anion resin stage, or carbon-containing stage.

26. A water filtration and remediation system for treating a contaminated fluid, comprising:
a fluid conduit or container; and
an iodine-containing stage disposed in or on the fluid conduit or container;
wherein the iodine-containing stage includes a concentric series of layers having interstices formed therein for allowing the contaminated fluid to flow through the concentric layers and contact the iodine-containing stage in order to treat the contaminated fluid.

27. The invention according to claim 26, wherein the interstices include pores of varying size.

28. The invention according to claim 27, wherein the pore size uniformly increases or decreases along a diameter portion of the iodine-containing stage.

29. The invention according to claim 26, further comprising a fluid outlet operably associated with the fluid conduit or container, wherein the treated fluid is selectively operable to exit the fluid outlet.

30. A water filtration and remediation system for treating a contaminated fluid, comprising:
a fluid conduit or container;
an iodine-containing stage disposed in or on the fluid conduit or container; and
a carbon-containing stage disposed in the fluid conduit or container;
wherein the contaminated fluid is permitted to flow through the fluid conduit or container and contact the iodine-containing stage in order to treat the contaminated fluid;
wherein the carbon-containing stage is permitted to be moved back and forth through the fluid conduit or container and contact the contaminated fluid in order to treat the contaminated fluid.

31. The invention according to claim 30, further comprising a fluid outlet operably associated with the fluid conduit or container, wherein the treated fluid is selectively operable to exit the fluid outlet.
